(19) United States
(12) Patent Application Publication
(10) Pub. No.: US 2025/0112295 A1
(43) Pub. Date: Apr. 3, 2025

(54) BATTERY SYSTEM

(71) Applicant: Toyota Jidosha Kabushiki Kaisha, Toyota-shi (JP)

(72) Inventors: Shintaro UTSUMI, Susono-shi (JP); Masato Ono, Nagoya-shi (JP); Kazuhito Kato, Toyota-shi (JP); Yusuke Kintsu, Miyoshi-shi (JP); Atsushi Yamanaka, Nagoya-shi (JP); Takaaki Goto, Seto-shi (JP); Hiroki Awano, Susono-shi (JP)

(73) Assignee: Toyota Jidosha Kabushiki Kaisha, Toyota-shi (JP)

(21) Appl. No.: 18/762,926

(22) Filed: Jul. 3, 2024

(30) Foreign Application Priority Data
Sep. 28, 2023 (JP) 2023-167781

(51) Int. Cl. H01M 10/6568; H01M 10/613; H01M 10/625; H01M 10/63; H01M 10/647; H01M 10/6561; H01M 50/211

(52) U.S. Cl. CPC H01M 10/6568; H01M 10/613; H01M 10/625; H01M 10/63; H01M 10/647; H01M 10/6561; H01M 50/211; H01M 2220/20

(57) ABSTRACT

A case constituting an outer shape of a second cooler disposed between the battery cells and containing a second fluid having a lower thermal conductivity than the first fluid therein is constituted by a buffer member capable of expanding and contracting in accordance with a flow rate of the second fluid in the case, and the control unit increases a flow rate of the second fluid to be supplied to the second cooler when the temperature of the battery cell is equal to or higher than a predetermined threshold value than when the temperature of the battery cell is lower than the threshold value.

### CROSS-REFERENCE TO RELATED APPLICATION

This application claims priority to Japanese Patent Application No. 2023-167781 filed on Sep. 28, 2023, incorporated herein by reference in its entirety.

### BACKGROUND

### 1. Technical Field

The present disclosure relates to a battery system.

### 2. Description of Related Art

Japanese Unexamined Patent Application Publication (Translation of PCT Application) No. 2022-550024 (JP 2022-550024 A) discloses a battery module including a battery cell stack constituted by stacking a plurality of pouch-type battery cells, a module frame that houses the battery cell stack, and a case of a heat sink connected to a lower portion of the module frame. The upper surface of the case of the heat sink is open, and a space is formed between the inner surface of the case and the bottom surface of the module frame. The heat sink is connected to a refrigerant conduit through which a refrigerant circulates. Therefore, the refrigerant flows through the space formed between the inner surface of the case and the bottom surface of the module frame.

Further, a plurality of partition wall portions formed of a shape memory alloy is provided on the inner surface of the heat sink. A flow path for the refrigerant is formed in the space by the partition wall portions. Therefore, the partition wall portions are deformed according to the temperature so that the flow path formed in the space is changed. Therefore, the temperature at the point where the temperature is high is relatively greatly reduced by the refrigerant flowing through the flow path.

### SUMMARY

With the battery module according to JP 2022-550024 A, it is difficult to suppress a thermal chain when a thermal chain occurs between the battery cells.

Further, in JP 2022-550024 A, the flow path is changed by deforming the partition wall portions formed of a shape memory alloy according to the temperature. However, it is difficult to rapidly change the flow path according to the temperature change. Therefore, the battery module according to JP 2022-550024 A has low responsiveness to the temperature change of the battery cells.

In view of the above, an object of the present disclosure is to provide a battery system capable of suppressing a thermal chain between battery cells and having good responsiveness to a temperature change of the battery cells.

A first aspect provides a battery system including: a plurality of battery cells; a first cooler disposed between the battery cells and accommodating a first fluid containing at least one of a gas and a liquid therein; a second cooler disposed between the battery cells and accommodating a second fluid having a lower thermal conductivity than the first fluid therein; and a control unit that controls supply of the first fluid to the first cooler and discharge of the first fluid from the first cooler and supply of the second fluid to the second cooler and discharge of the second fluid from the second cooler, in which: a case that constitutes an outer shape of the second cooler is constituted by a buffer member capable of expansion and contraction according to a flow rate of the second fluid in the case; and the control unit increases the flow rate of the second fluid to be supplied to the second cooler when a temperature of the battery cells is equal to or more than a predetermined threshold value compared to when the temperature of the battery cells is less than the threshold value.

In the battery system according to the first aspect, the control unit increases the flow rate of the second fluid to be supplied to the second cooler when the temperature of the battery cells is equal to or more than a predetermined threshold value compared to when the temperature of the battery cells is less than the threshold value. Therefore, when the temperature of the battery cells is equal to or more than the threshold value, the case constituting the outer shape of the second cooler expanded by the second fluid comes into contact with adjacent battery cells. The second fluid has a lower thermal conductivity than the first fluid. That is, the second fluid has a higher thermal insulation property than the first fluid. Therefore, the second cooler suppresses the occurrence of a thermal chain in which the heat of one battery cell having a high temperature equal to or more than the threshold value is transmitted to other battery cells.

Further, when the temperature of the battery cells is equal to or more than the predetermined threshold value, the flow rate of the second fluid supplied to the second cooler increases. Therefore, the battery system according to the first aspect has good responsiveness to temperature change of the battery cells.

Further, the case constituting the outer shape of the second cooler is constituted by a buffer member capable of expansion and contraction. Therefore, when the battery cells vibrate, for example, the second cooler can suppress the vibration being transmitted to other battery cells.

Further, when the temperature of the battery cells is less than the threshold value, the flow rate of the second fluid supplied to the second cooler decreases, and thus the second cooler (case) becomes smaller. Therefore, when the temperature of the battery cells is less than the threshold value, the volume of the second cooler (case) can be reduced.

Further, since the first fluid is supplied to the first cooler by the control unit, the heat generated in the battery cells can be absorbed by the first cooler. That is, the battery system according to the first aspect can achieve both cooling and heat insulation of the battery cells.

A second aspect provides the battery system, further including: a first pipe which is connected to the first cooler and in which the first fluid flows; and a second pipe which is connected to the second cooler and in which the second fluid flows.

With the battery system according to the second aspect, the configuration for implementing the supply of the first fluid to the first cooler and the discharge of the first fluid from the first cooler and the supply of the second fluid to the second cooler and the discharge of the second fluid from the second cooler can be implemented by a simple configuration.

A third aspect provides the battery system, further including a first pump that generates a force that enables supply of the first fluid to the first cooler and discharge of the first fluid from the first cooler, and a second pump that generates a force that enables supply of the second fluid to the second cooler and discharge of the second fluid from the second cooler, the pumps being controlled by the control unit.

With the battery system according to the third aspect, the configuration for implementing the supply of the first fluid to the first cooler and the discharge of the first fluid from the first cooler and the supply of the second fluid to the second cooler and the discharge of the second fluid from the second cooler can be implemented by a simple configuration.

A fourth aspect provides the battery system, in which the first pipe and the second pipe are part of a circulation system that circulates the first fluid and the second fluid.

The battery system according to the fourth aspect can circulate the first fluid supplied to the first cooler and the second fluid supplied to the second cooler.

A fifth aspect provides the battery system, in which the second fluid is a gas.

With the battery system according to the fifth aspect, there is little possibility that a short circuit occurs in the battery cells due to the second fluid.

As described above, the battery system according to the present disclosure has an excellent effect that the thermal chain between the battery cells can be suppressed and the responsiveness to temperature change of the battery cells is good.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an overall configuration diagram of a battery system according to an embodiment;

FIG. 2 is a cross-sectional view of the battery module shown in FIG. 1 taken along line 2-2;

FIG. 3 is a cross-sectional view similar to FIG. 2 when the temperature of the battery cell becomes equal to or higher than the threshold;

FIG. 4 is a control block diagram of the control device shown in FIG. 1;

FIG. 5 is a functional block-diagram of a controller; and

FIG. 6 is a flow chart illustrating a process executed by CPU of the control device.

### DETAILED DESCRIPTION OF EMBODIMENTS

Hereinafter, an embodiment of a battery system according to the present disclosure will be described with reference to the accompanying drawings. The arrow FR shown as appropriate in the drawing indicates the front side, the arrow LH indicates the left side, and the arrow UP indicates the upper side.

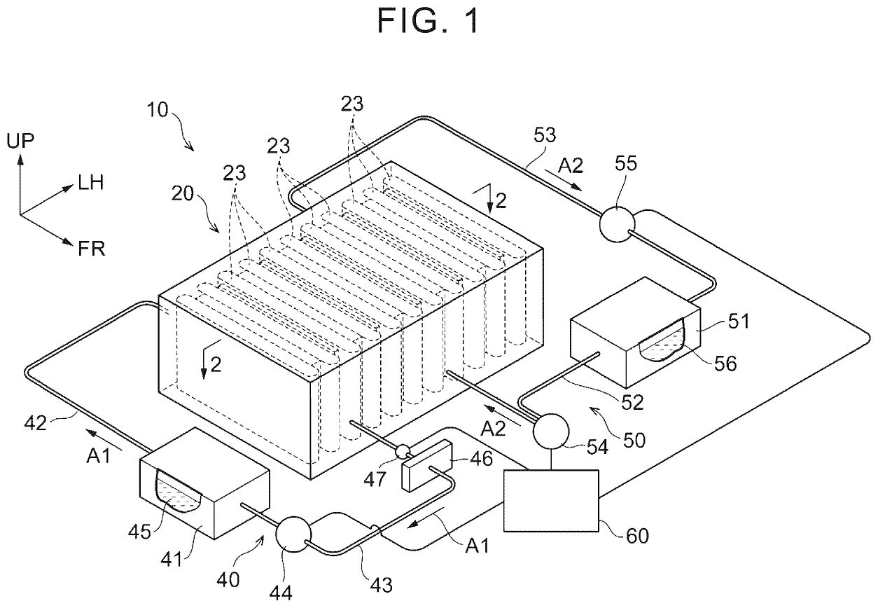

The battery system 10 shown in FIG. 1 is mounted on vehicles, for example BEV (Battery Electric Vehicle) or HEV (Hybrid Electric Vehicle). However, the battery system 10 may be mounted separately from the vehicle.

As shown in FIG. 1, the battery system 10 includes a battery module 20, a first fluid supply device (circulation system) 40, a second fluid supply device (circulation system) 50, and a control device 60.

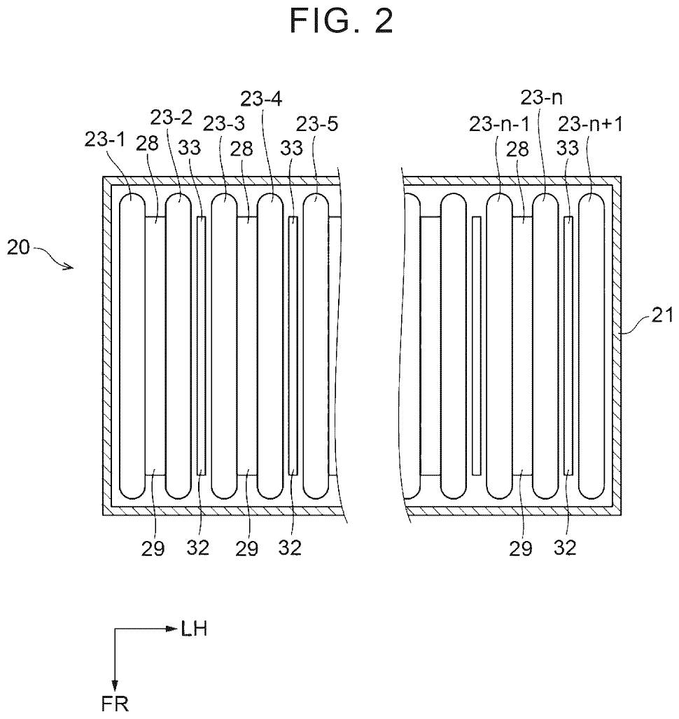

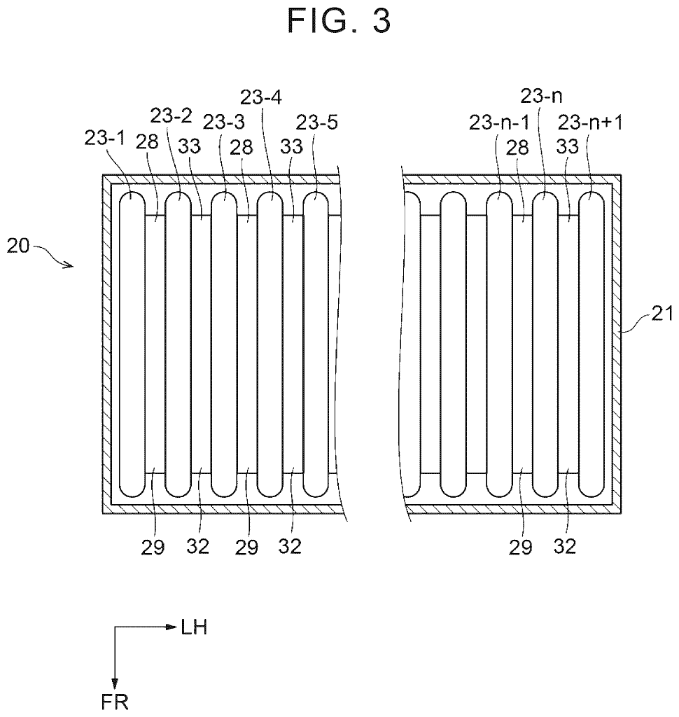

As illustrated in FIGS. 2 and 3, the battery module 20 illustrated in FIG. 1 includes a battery case 21, a plurality of battery cells 23, a plurality of first coolers 28, and a plurality of second coolers 32.

The battery case 21 is a hollow body having a rectangular parallelepiped shape. A plurality of battery cells 23 are provided inside the battery case 21. The battery cell 23 of the present embodiment is a pouch-type (laminate-type) lithium ion secondary battery. Each battery cell 23 is housed inside the battery case 21 in a state of being arranged in the left-right direction. Further, the battery cells 23 are electrically connected to each other.

As shown in FIGS. 2 and 3, in the following explanation, the respective battery cells 23 may be referred to as 23-1, 23-2, 23-3, 23-4, 23-5 . . . 23-n−1, 23-n, 23-n+1 in order from the right side. Here, n is a natural number equal to or greater than 1. A first cooler 28 is provided between the battery cell 23-1 and the battery cell 23-2, between the battery cell 23-3 and the battery cell 23-4, and between the battery cell 23-n−1 and the battery cell 23-n. The first case 29 constituting the outer shape of each first cooler 28 has a rectangular parallelepiped shape. The first case 29 is made of a watertight material. The first case 29 can retain its shape unless a large external force is applied thereto. The first case 29 is made of a material having good thermal conductivity. For example, the first case 29 is made of metal. The left and right side surfaces of each first case 29 are in contact with the side surfaces of the adjacent battery cells 23.

As shown in FIGS. 2 and 3, a second cooler 32 is provided between the battery cell 23-2 and the battery cell 23-3, between the battery cell 23-4 and the battery cell 23-5, and between the battery cell 23-n and the battery cell 23-n+1. The second case (case) (buffer member) 33 constituting the outer shape of the second cooler 32 is made of a material having flexibility and airtightness. That is, the second case is inflatable and retractable. The thermal conductivity of the second case 33 is lower than that of the first case 29.

As shown in FIG. 1, the first fluid supply device 40 includes a first tank 41, a pipe (first pipe) 42, a pipe (first pipe) 43, a first electric pump (first pump) 44, a first fluid 45, a heat exchanger 46, and a pressure sensor 47. One end portion of the pipe 42 and the pipe 43 is connected to the first tank 41 in a watertight manner. The other end portions of the pipe 42 and the pipe 43 are connected to the battery case 21. The other end portion of the pipe 42 is branched inside the battery case 21, and each branch portion is connected to the first cooler 28 (first case 29) in a watertight state (not shown). The other end portion of the pipe 43 is branched inside the battery case 21, and each branch portion is connected to the first case 29 in a watertight state (not shown). A first electric pump 44 is connected to an intermediate portion of the pipe 43. Further, a first fluid 45 (see FIG. 1) is provided inside the first tank 41, inside the pipe 42, inside the pipe 43, and inside each first case 29. When the first electric pump 44 operates, the first fluid 45 circulates inside the first tank 41, the pipe 42, the first cases 29, and the pipe 43 along the arrow A1 indicated in FIG. 1 by the force generated by the first electric pump 44. Further, an intermediate portion of the pipe 43 is connected to the heat exchanger 46. When the battery system 10 is mounted on a vehicle, the heat exchanger 46 is, for example, a radiator. Further, the pipe 43 is provided with a pressure sensor 47. The pressure sensor 47 detects a pressure (Pa) of the first fluid 45 flowing inside the pipe 43.

As shown in FIG. 1, the second fluid supply device 50 includes a second tank 51, a pipe (second pipe) 52, a pipe (second pipe) 53, a second electric pump (second pump) 54, a third electric pump (second pump) 55, and a second fluid 56. One end portion of the pipe 52 and the pipe 53 is airtightly connected to the second tank 51. The other end portions of the pipe 52 and the pipe 53 are connected to the battery case 21. The other end portion of the pipe 52 is branched inside the battery case 21, and each branch portion is airtightly connected to the second cooler 32 (second case 33) (not shown). The other end portion of the pipe 53 is branched inside the battery case 21, and each of the branched portions is airtightly connected to the second case 33 (not shown). A second electric pump 54 is connected to an intermediate portion of the pipe 52, and a third electric pump 55 is connected to an intermediate portion of the pipe 53. Further, a second fluid 56 (see FIG. 1) is provided inside the second tank 51. When the second electric pump 54 and the third electric pump 55 are in operation, the second fluid 56 in the second tank 51 circulates inside the pipe 52, the second cases 33, the pipe 53, and the second tank 51 in the directions indicated by the arrow A2 in FIG. 1. The second fluid 56 in the second tank 51 circulates by the force generated by the second electric pump 54 and the third electric pump 55. Since a check valve (not shown) is provided inside the pipe 52 and the pipe 53, the second fluid 56 does not flow in the inside of the second tank 51, the pipe 52, and the pipe 53 in the direction opposite to the direction of the arrow A2. On the other hand, when the second electric pump 54 is in the non-operating state and the third electric pump 55 is in the operating state, second fluid 56 in the portion located closer to battery module 20 than the second electric pump 54 of the pipe 52, the second fluid 56 in the respective second cases 33, and the second fluid 56 in the pipe 53 are returned to the second tank 51. The second fluid 56 in the portion located on the battery module 20 side, the second fluid 56 in the respective second cases 33, and the second fluid 56 in the pipe 53 are returned to the second tank 51 by the force generated by the third electric pump 55, as shown in the arrow A2 in FIG. 1. The thermal conductivity of the second fluid 56 is less than the thermal conductivity of the first fluid 45. The second fluid 56 is, for example, air. However, the second fluid 56 may be a gas different from air. For example, the second fluid 56 may be nitrogen or carbon dioxide.

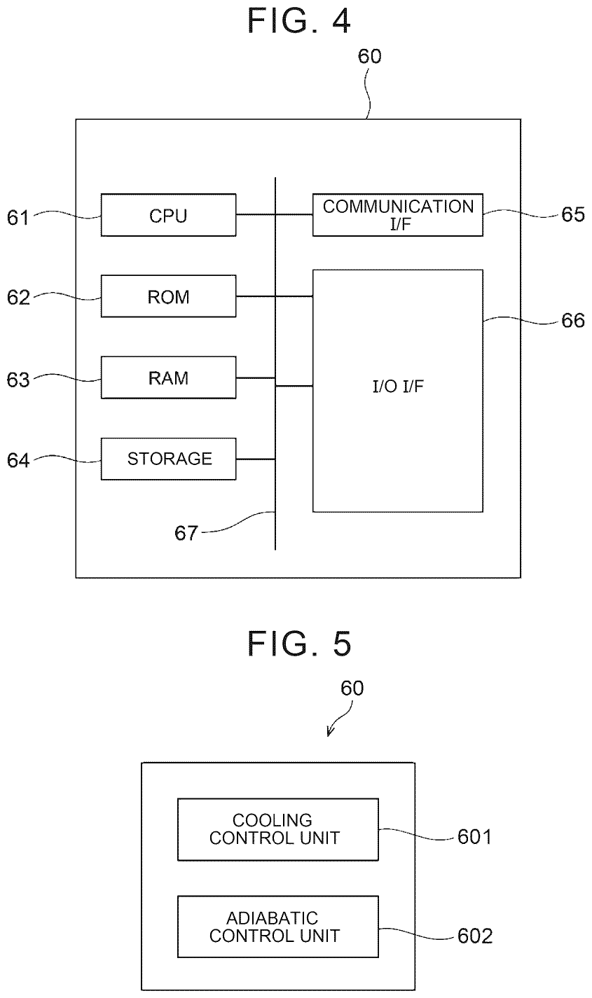

As shown in FIG. 1, the first electric pump 44, the pressure sensor 47, the second electric pump 54, and the third electric pump 55 are connected to the control device 60. As illustrated in FIG. 4, the control device 60 includes a CPU (Central Processing Unit: processor) (control unit) 61, a ROM (Read Only Memory) 62, RAM (Random Access Memory) 63, a storage 64, a communication I/F (Interface) 65, and an input/output I/F 66. CPU 61, ROM 62, RAM 63, the storage 64, the communication I/F 65, and the input/output I/F 66 are communicably connected to each other via a bus 67.

CPU 61 is a central processing unit that executes various programs and controls each unit. That is, CPU 61 reads the program from ROM 62 or the storage 64, and executes the program using RAM 63 as a working area. CPU 61 performs control of the respective components and various arithmetic processes (information processing) in accordance with programs recorded in ROM 62 or the storage 64.

ROM 62 stores various programs and various data. The data includes, for example, data related to a threshold pressure described later.

RAM 63 temporarily stores a program/data as a working area. The storage 64 is constituted by a storage device such as an HDD (Hard Disk Drive) or an SSD (Solid State Drive), and stores various programs and various data. The communication I/F 65 can communicate with a control device other than the control device 60 via an external bus.

As illustrated in FIG. 5, the control device 60 includes a cooling control unit 601 and a heat insulation control unit 602 as a functional configuration. The cooling control unit 601 and the heat insulation control unit 602 are realized by CPU 61 of the control device 60 reading out and executing a program stored in ROM 62.

The cooling control unit 601 controls the first electric pump 44. That is, the cooling control unit 601 supplies the electric power of the fluid control power supply (not shown) to the first electric pump 44 to operate the first electric pump 44.

When the detected value of the pressure sensor 47 is less than the predetermined threshold pressure, the heat insulation control unit 602 supplies the power of the fluid control power source to the third electric pump 55 and does not supply the power to the second electric pump 54. Therefore, the second electric pump 54 is in the non-operating state and the third electric pump 55 is in the operating state. When the detected value of the pressure sensor 47 is less than the threshold pressure, it is estimated that the temperature of all the battery cells 23 is less than the predetermined threshold. In other words, when the detected value of the pressure sensor 47 is less than the threshold pressure, it is estimated that all the battery cells 23 are in the normal state. When the second electric pump 54 is deactivated and the third electric pump 55 is activated, the second case 33 of each of the second coolers 32 is substantially in a vacuum state. Therefore, as shown in FIG. 2, the thickness of each of the second cases 33 is reduced. On the other hand, when the detected value of the pressure sensor 47 is equal to or higher than the threshold pressure, the heat insulation control unit 602 supplies the electric power of the fluid control power source to the second electric pump 54 and the third electric pump 55. Therefore, the second electric pump 54 and the third electric pump 55 are in the operating state. When the detected value of the pressure sensor 47 is equal to or higher than the threshold pressure, it is estimated that the temperature of the at least one battery cell 23 is equal to or higher than the threshold. In other words, when the detected value of the pressure sensor 47 is equal to or greater than the threshold pressure, it is estimated that the at least one battery cell 23 is in an abnormal state. When the second electric pump 54 and the third electric pump 55 are activated, as shown in FIG. 2, the second fluid 56 circulates inside the pipe 52, the second cases 33, the pipe 53, and the second tank 51 in the directions indicated by the arrow A2 in FIG. 1. As a result, the thickness of each second case 33 increases, and each second cooler 32 comes into contact with an adjacent battery cell 23.

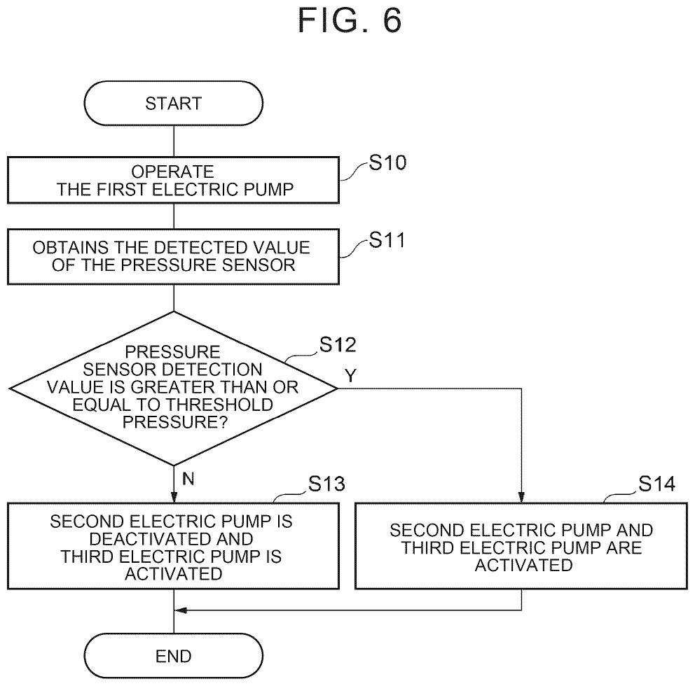

Next, a process executed by CPU 61 of the control device 60 will be described. CPU 61 repeatedly executes the process of the flow chart shown in FIG. 6 every time the predetermined period elapses.

In S10 (hereinafter, the letters of the steps are omitted), CPU 61 activates the first electric pump 44. As a result, the first fluid 45 circulates inside the first tank 41, the pipe 42, the first case 29, and the pipe 43 along the arrow A1 in FIG. 1. Therefore, each battery cell 23 is cooled by the first fluid 45. In addition, heat of the first fluid 45, which is heated by removing heat from each battery cell 23, is absorbed by the heat exchanger 46.

When S10 process is completed, CPU 61 proceeds to S11 to acquire a detected value of the pressure sensor 47 from the pressure sensor 47.

When S11 process is finished, CPU 61 proceeds to S12 to determine whether the detected value of the pressure sensor 47 is equal to or greater than the threshold pressure.

If S12 determines No, CPU 61 proceeds to S13. That is, when all the battery cells 23 are in the normal state, CPU 61 proceeds to S13. In S13, CPU 61 causes the second electric pump 54 to be inactive and the third electric pump 55 to be operational.

On the other hand, when Yes is determined in S12, CPU 61 proceeds to S14. That is, when the at least one battery cell 23 is in an abnormal condition, CPU 61 proceeds to S14. In S14, CPU 61 activates the second electric pump 54 and the third electric pump 55. Therefore, each second case 33 is expanded by the second fluid 56 supplied to each second case 33, and each second case 33 comes into contact with the side surface of the adjacent battery cell 23.

When the processing of S13 or S14 is completed, CPU 61 temporarily ends the processing of the flow chart of FIG. 6.

As described above, in the battery system 10 of the present embodiment, when CPU 61 determines that the temperature of the battery cell 23 is equal to or higher than the threshold value based on the detected value of the pressure sensor 47, the flow rate of the second fluid 56 to be supplied to the second cooler 32 is increased from the time when the temperature of the battery cell 23 is lower than the threshold value. Therefore, when the temperature of the battery cell 23 is equal to or higher than the threshold value, the second case 33 expanded by the second fluid 56 comes into contact with the side surface of the adjacent battery cell 23. The second fluid 56 has a lower thermal conductivity than the first fluid 45. Further, the thermal conductivity of the second case 33 is lower than that of the first case 29. That is, the second fluid 56 has a higher heat insulating property than the first fluid 45, and the second case 33 has a higher heat insulating property than the first case 29. Therefore, the generation of a heat chain in which the heat of the battery cells 23 having a high temperature equal to or higher than the threshold value is transferred to the other battery cells 23 is suppressed by the second case 33 and the second fluid 56.

Further, when the temperature of the battery cell 23 is equal to or higher than the threshold value, the flow rate of the second fluid 56 supplied to the second cooler 32 increases. Therefore, the responsiveness of the battery cell 23 of the battery system 10 to the temperature change is good.

Further, the second case 33 of the second cooler 32 is made of a flexible material capable of expanding and contracting. That is, the second case 33 is constituted by a buffer member. Therefore, for example, when one battery cell 23 vibrates, the second case 33 can suppress the vibration from being transmitted to another battery cell 23.

Further, when the temperature of the battery cell 23 is less than the threshold value, the flow rate of the second fluid 56 supplied to the second cooler 32 decreases, and thus the second case 33 decreases. Therefore, when the temperature of the battery cell 23 is less than the threshold value, the volume of the second case 33 can be reduced.

Further, since the first fluid 45 is supplied to the first cooler 28, the heat generated in the battery cell 23 can be absorbed by the first cooler 28. That is, the battery system 10 can achieve both cooling and heat insulation of the battery cells 23.

Further, the first fluid supply device 40 and the second fluid supply device 50 are realized by a simple configuration.

Further, since the second fluid 56 is gas, even if the second fluid 56 leaks from the pipe 52 in the battery case 21, there is a small possibility that a short circuit occurs in the battery cell 23 due to the second fluid 56.

Although the battery system according to the embodiment has been described above, these can be appropriately changed in design without departing from the gist of the present disclosure.

For example, a temperature sensor for detecting the temperature of the first fluid 45 may be provided in the pipe 42 or the pipe 43, and CPU 61 may determine whether the temperature of the battery cell 23 is equal to or higher than a threshold based on the detection result of the temperature sensor.

In addition, a sensor for measuring the amount of the first fluid 45 in the first tank 41 may be provided inside the first tank 41. The higher the temperature of the first fluid 45, the lower the amount of the first fluid 45 in the first tank 41. Therefore, CPU 61 may determine whether or not the temperature of the battery cell 23 is equal to or higher than the threshold value based on the detection result of the sensor.

Further, a temperature sensor for detecting the temperature of the first cooler 28 may be provided in the at least one first cooler 28, and CPU 61 may determine whether the temperature of the battery cell 23 is equal to or higher than a threshold based on the detection result of the temperature sensor.

The number of second coolers 32 provided in the battery module 20 may be any number. For example, the number of the second coolers 32 provided in the battery module 20 may be one.

A first cooler 28 and a second cooler 32 may be provided between two adjacent battery cells 23.

The first fluid may be a gas having a higher thermal conductivity than the second fluid. In addition, the first fluid may be constituted by a liquid and a gas having a higher thermal conductivity than the second fluid.

The second fluid may be a liquid having a lower thermal conductivity than the first fluid. In this case, the second fluid supply device may have the same configuration as the first fluid supply device 40.

When the temperature of the battery cell 23 is less than the threshold value, the second fluid 56 may be supplied to the second cooler 32. However, in this case, the supply amount of the second fluid 56 to the second cooler 32 is increased when the temperature of the battery cell 23 is equal to or higher than the threshold value than when the temperature of the battery cell 23 is lower than the threshold value.

A heat exchanger may be connected to the pipe 52 or the pipe 53.

What is claimed is:

1. A battery system comprising:
a plurality of battery cells;
a first cooler disposed between the battery cells and accommodating a first fluid containing at least one of a gas and a liquid therein;
a second cooler disposed between the battery cells and accommodating a second fluid having a lower thermal conductivity than the first fluid therein; and
a control unit that controls supply of the first fluid to the first cooler and discharge of the first fluid from the first cooler and supply of the second fluid to the second cooler and discharge of the second fluid from the second cooler, wherein:
a case that constitutes an outer shape of the second cooler is constituted by a buffer member capable of expansion and contraction according to a flow rate of the second fluid in the case; and
the control unit increases the flow rate of the second fluid to be supplied to the second cooler when a temperature of the battery cells is equal to or more than a predetermined threshold value compared to when the temperature of the battery cells is less than the threshold value.

2. The battery system according to claim 1, further comprising:
a first pipe which is connected to the first cooler and in which the first fluid flows; and
a second pipe which is connected to the second cooler and in which the second fluid flows.

3. The battery system according to claim 1, further comprising a first pump that generates a force that enables supply of the first fluid to the first cooler and discharge of the first fluid from the first cooler, and a second pump that generates a force that enables supply of the second fluid to the second cooler and discharge of the second fluid from the second cooler, the pumps being controlled by the control unit.

4. The battery system according to claim 2, wherein the first pipe and the second pipe are part of a circulation system that circulates the first fluid and the second fluid.

5. The battery system according to claim 1, wherein the second fluid is a gas.
